(19) United States
(12) Patent Application Publication
(10) Pub. No.: US 2009/0075019 A1
(43) Pub. Date: Mar. 19, 2009

(54) Internal Lining and Method for the Production Thereof

(75) Inventor: Paul Loos, Thalheim bei Wels (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: ESKA Lederhandschunhfabrik, A 4600 Thalheim bei Wels (AT)

(21) Appl. No.: 11/664,876

(22) PCT Filed: Sep. 26, 2005
(86) PCT No.: PCT/AT05/00385

§ 371 Date: Jun. 16, 2008

(30) Foreign Application Priority Data
Oct. 7, 2004 (AT) A 1676/2004

(51) Int. Cl. B32B 3/06; D03D 15/00; D04B 1/22; B32B 15/14; A41D 19/00; A41D 31/02; A41D 27/24; B32B 38/04; B32B 15/02; B32B 3/10

(52) U.S. Cl. 428/102; 442/228; 442/316; 442/376; 442/380; 428/196; 156/250

(57) ABSTRACT

An internal lining of several layers having anti-microbial effect is described for an item of equipment suitable for at least temporarily covering body parts; in particular, the layers include at least one layer made from a woven fabric and/or knitted and/or non-woven fabric with an anti-microbial effect wherein the fabric contains a metal, which metal is integrated in a filament, a fiber and/or a spunbonded fiber or spunbonded yarn; and at least one other layer of a semi-permeable membrane made from polytetrafluoroethylene (PTFE), and/or a polymeric laminate. The method of production of the multiple layered internal lining with an antimicrobial effect is also disclosed.

### CROSS-REFERENCE TO RELATED APPLICATIONS

This is a national phase application of PCT Patent Application No. PCT/AT2005/000385, filed Sep. 26, 2005 which claims priority from Austrian Application No. A 1676/2004, filed Oct. 7, 2004. The disclosure of each such application is hereby incorporated by reference in its entirety where appropriate for teachings of additional or alternative details, features, and/or technical background, and priority is asserted from each.

### FIELD OF INVENTION

The invention relates to an internal lining for an item of equipment for at least temporarily covering body parts, in particular items of clothing, quilts, sleeping bags, comprising several layers with an anti-microbial effect, wherein at least one layer made from a woven and/or non-woven fabric or from leather is provided, and a method of producing an internal lining by means of which several layers, in particular at least one layer made from a woven and/or non-woven fabric or from leather with an anti-microbial effect and another layer made from semi-permeable membrane, are cut into individual pattern pieces corresponding to the desired internal lining and shaped or alternatively are cut and formed already joined, after which the at least two layers are joined to one another at least partially covering one another and optionally in a semi-permeable manner, as well as the use of the internal lining and an item of equipment incorporating an internal lining.

### BACKGROUND OF THE INVENTION

Internal linings for items of equipment of various types are used in a whole range of different applications.

This being the case, internal linings used for the same item of equipment often have to satisfy a range of different requirements. For example, it might be necessary to combine both heat-insulating and water repelling properties in one object along with air permeability. These days, the demand by consumers for functional clothing is constantly increasing. In addition to clothing which repels water but is permeable to sweat, there is also an increasing demand for clothing treated to impart anti-microbial properties to it due to the growing awareness of hygiene and an increasing knowledge of the potentially harmful effects of micro-organisms.

Due to the different properties of membranes and woven fabrics or knitted fabrics, processing them together is problematic and items of clothing incorporating them are not always as comfortable to wear as they could be.

In the case of glove linings, for example, individual pattern pieces have to be cut out both for the membrane and for the textile lining material and then have to be assembled. Since the glove internal lining would become permeable at the stitched seams as the membrane pattern pieces are being stitched together, they have to be bonded or welded, or the seams must at least be covered with a sealing means once the seams have been stitched. The pattern pieces made from the textile lining material, on the other hand, are stitched to one another in the standard manner. The two resultant lining layers of textile material and membrane are then jointly stitched to the glove outer material. The water-repellent textile lining material facing the hand, which tends to adhere to the always slightly damp hand, thereby resulting in an unpleasant smell, can easily be pulled out of the glove and simultaneously turn inside out when the glove is being removed, especially as the membrane lying between the fabric lining and glove outer material has smooth and, due to its water-repellent property, dry surfaces.

Patent specification WO 89/07523 discloses how membranes—in particular semi-permeable ones—with stretchable—in particular knitted—textile material can be joined on one or two sides in order to produce internal linings for gloves and socks or to produce gloves and socks themselves. Gloves of socks of this type are intended to be particularly comfortable to wear—in terms of repelling water and heat insulation—which is attributable firstly to the fact that there are absolutely no perforations in the membrane and secondly to crimping produced during production in order to create the minute air pockets. However, the production of such gloves or sockets and their internal linings is restricted to the use of gloves or socks made from ready-made layers of knitted fabrics which stretch, and which are placed together with the membrane layer pieces and partially bonded across a large surface area, and the membrane layer pieces are welded to one another in the areas where they overlap. Another textile layer may be applied to the other side of the membrane layer only by stretching the membrane textile layer and the other textile layer again and by bonding in a similar manner and then securing them at joining points in the manner described above.

Items of clothing for which non-stretch knitted textile fabrics have to be used are described in patent specification WO 89/07523 and can not be provided with an internal lining containing a semi-permeable membrane. Likewise, this type of manufacturing is not suitable for making items of clothing requiring complicated cutting techniques where emphasis is placed on obtaining a good fit corresponding to the different sizes of the clothes. This requirement can be achieved to only a limited degree in the situation where an item of clothing or its internal lining is made in this manner, namely stretching, (hot) bonding and shrinking and possibly then stretching, (hot) bonding and shrinking yet again.

Patent specification JP 06136603 A describes the manufacture of gloves with an anti-bacterial and deodorizing function. In order to impart efficient anti-bacterial and deodorizing properties to the glove, the internal face of the woven fiber is subjected to an appropriate treatment. A powder containing an anti-bacterial metallic composition combined with a thermoplastic synthetic resin in water or a solution is applied, which has a low melting point. The suspension is adsorbed by the internal face of the woven fabric structure of the glove and is dried by a heat treatment operated at a temperature above the softening point of the thermoplastic synthetic resin with a low melting point. This suppresses the unpleasant odor which occurs in gloves, especially those used to fillet raw fish, and the working gloves also have a low air permeability.

Patent specification JP 2001/299982 A discloses a sports glove made from leather and which can be used for golf or other types of sport. The objective of this JP-A is to produce a glove which has good slipping properties making them easy to put on, even in the presence of moisture. This objective is achieved on the basis of a glove made from natural leather, from which a surface layer is peeked off from a silver surface. With this sports glove, the silver surface side constitutes the internal face of the glove.

### SUMMARY OF THE INVENTION

The objective of the invention is to propose an internal lining for an item of equipment which is comfortable to wear and which effectively prevents an unpleasant odour from forming whilst simultaneously eliminating any safety risk for the consumer or for the environment.

This objective is achieved by the invention due to the fact that an internal lining is proposed which comprises at least one layer made from a woven and/or non-woven fabric or leather with an anti-microbial effect, a method of producing an internal lining comprising several layers, in particular at least one layer made from a woven and/or non-woven fabric or leather with an anti-microbial effect and another layer made from a semi-permeable membrane cut into individual pattern pieces corresponding to the desired internal lining and shaped, after which at least these two layers are positioned at least partially covering one another and joined, optionally in a semi-permeable manner, a method of producing an internal lining, whereby the at least one layer made from a woven and/or non-woven fabric or leather with an anti-microbial effect and the at least one layer of semi-permeable membrane are at least partially joined to one another prior to cutting, after which these layers are cut jointly and the pattern pieces of the internal lining shape are joined accordingly, the use of the internal lining and an item of equipment with an internal lining, the latter comprising a layer of semi-permeable membrane and a layer of woven and/or non-woven fabric or leather with anti-microbial properties and optionally an additional layer made from a woven and/or non-woven fabric or leather. The use of clothing with an imparted anti-microbial function makes the product different from others on the market because the items of clothing treated to render them anti-microbial focus on the aspect of cleanliness and freshness. The consumer's demand for both comfort and functionality are satisfied. It has been found that the anti-microbial effect advantageously prevents growth of bacteria, viruses, fungi and other micro-organisms, as a result of which use of the internal lining to produce items of equipment can eliminate the formation of unpleasant odors and eliminate skin diseases psychologically associated with odor-generating bacteria and fungi. It has also advantageously been found that the anti-microbial properties of the internal lining enable it to be placed on damaged woven fabric or wounds for example without causing infections and even promotes the wound healing process by assisting the bleeding process. Another advantage is the fact that this layer with an anti-microbial effect constitutes a strong barrier which prevents the spread of bacteria that are resistant to antibiotics and which are responsible for infections which occur in hospitals. The number of such infections is currently rising in many industrialized countries.

In one embodiment of the invention in which at least one other layer of a semi-permeable membrane is provided, in particular made from polytetrafluoroethylene (PTFE), a laminate comprising polyvinyl chloride, polyurethane, polyether amide, polyether ester amide, polyolefin components, polyester components or a mixture of these, the internal lining may also be water-repellent but still permeable to air. The advantage of this is that the temperature can be regulated and hence also transpiration, so that moisture can be carried away from the skin of the wearer onto the surface of the item of equipment.

In another embodiment, the woven and/or non-woven fabric or leather incorporates the anti-microbial effect due to a metal and the metal is selected from a group comprising silver, gold, copper, platinum and/or a mixture of these, and only elements which are natural are used. Accordingly, no chemicals are used. An internal lining containing such elements is both pleasant for the wearer and causes absolutely no damage to the environment.

The metal, in particular silver, is contained in a proportion by percentage with an upper threshold of 80%, preferably 35%, in particular 20% and a lower threshold of 0.5%, preferably 1%, in particular 5%, in the layer of a woven and/or non-woven fabric or leather with an anti-microbial effect, as a result of which the original properties of being pleasant to wear or comfortable to wear as well as suppleness are preserved. The use of metal, in particular silver, causes bacteria, fungi, viruses and algae to be killed directly or after some time due to the fact that silver with an oligo-dynamic effect is used. Advantageously, there is also a significant reduction in the possibility of interaction between germs and the surface due to the correspondingly free surface energy.

The metal is integrated in a filament, a fiber and/or a spunbonded fiber or yarn, which means that the internal lining does not have to be separately coated with the metal element and the anti-microbial properties can already be imparted to the internal lining during production. This obviates the need for an additional work step during the process of manufacturing the internal lining.

In an alternative embodiment, the metal may be in the form of a coating or a powder applied to the at least one layer (3) made from a woven and/or non-woven fabric or leather and/or the other layer (4) of semi-permeable membrane (5), in which case a standardized manufacturing process can be used to produce it, thereby keeping manufacturing costs low.

The particulate material has a particle size selected from a range with a lower threshold of 1 μm, preferably 0.2 μm, in particular 20 μm, and an upper threshold of 500 μm, preferably 250 μm, in particular 200 μm, and a uniform coating can be applied to the internal lining.

The metal may be flocculated, bonded, laminated, coated, vapor deposited, sprayed, dipped and/or impregnated, which means that standardized manufacturing processes may be used to produce an internal lining coated with metal.

The at least one other layer of semi-permeable membrane may be disposed adjacent to, optionally directly adjacent to, the at least one layer made from a woven and/or non-woven fabric or leather with an anti-microbial effect, so that the effects of the two layers, namely the water-repellent properties of the semi-permeable membrane on the one hand and the anti-bacterial, odour-inhibiting, temperature regulating and anti-static properties of the layer containing the metal work in the best possible way.

Alternatively, the at least one layer made from a woven and/or non-woven fabric or leather with an anti-microbial effect may be applied at least partially to another layer of semi-permeable membrane across its entire surface or partially, in particular in a dotted or network pattern, such as flocculated, bonded, laminated, coated, vapor deposited, sprayed and/or impregnated, in which case the semi-permeable membrane will have the anti-microbial properties directly on its surface or even integrated in the membrane.

In an alternative embodiment, the other layer of semi-permeable membrane is disposed between the at least one layer made from a woven and/or non-woven fabric or leather with an anti-microbial effect and an additional layer made from a woven and/or non-woven fabric or leather, in which case the properties of the additional layer can also be combined with the properties outlined above. One example would be to impart a function to the internal lining, additionally offering heat regulation, flame retarding properties, properties to limit injury by blades or similar.

In another embodiment, the at least one other layer of semi-permeable membrane, the at least one layer made from a woven and/or non-woven fabric or leather with an anti-microbial effect and optionally the additional layer made from a woven and/or non-woven fabric or leather may be joined to one another by their full surface, which prevents the two layers from slipping on one another. The full-surface joining of the different layers to one another also imparts a certain degree of stiffness, which gives the internal lining an advantage when used in specific applications because it increases dimensional stability.

It has also been found to be of advantage if the at least one other layer of semi-permeable membrane, the at least one layer made from a woven and/or non-woven fabric or leather with an anti-microbial effect and optionally the additional layer made from a woven and/or non-woven fabric or leather are joined in a non-slip arrangement across at least a part of the surface, which does not impair wearing comfort on the one hand and enables a certain degree of dimensional stability to be preserved on the other hand.

In one embodiment of the internal lining proposed by the invention, at least the at least one layer made from a woven and/or non-woven fabric or leather with an anti-microbial effect and the at least one other layer of semi-permeable membrane and optionally the additional layer made from a woven and/or non-woven fabric or leather are joined to one another at least partially, in particular at their contact surfaces, in the form of a plurality of dots or a network pattern, by means of an adhesive layer which may or may not be activatable so that work sequences are advantageously not hampered and the layers to be processed, in other words the cut and assembled pattern pieces, are placed one on top of one another with their surfaces congruent and oriented. The adhesive agent can then be activated by heat or pressure, for example, and the individual layers joined to one another in the desired manner, irrespective of whether they have already been processed or not.

The layers may be joined to one another by welding, hot sealing, lamination and/or stitching along join lines, and the water-impermeable but sweat permeable property of the semi-permeable membrane and the odor-inhibiting, anti-bacterial, temperature-regulating and anti-static effect of the layer incorporating the metal can be preserved.

The internal lining comprises pattern pieces of at least one woven and/or non-woven fabric or leather with an anti-microbial effect on the one hand and at least one other layer of semi-permeable membrane on the other hand for each layer, which are joined to one another at join lines, and the join lines of the other layer of semi-permeable membrane are welded, in which case the join lines of the parts of the layer made from a woven and/or non-woven fabric or leather with an anti-microbial effect are joined to one another separately from the other layer of semi-permeable membrane, preferably stitched, so that each layer can be joined using the joining method best suited to it.

At least one layer made from a woven and/or non-woven fabric or leather with an anti-microbial effect and an additional layer made from a woven fabric and/or knitted fabric or leather are advantageously provided, and the other layer of semi-permeable membrane is disposed between the layer made from a woven and/or non-woven fabric or leather with an anti-microbial effect and the additional layer made from a woven and/or non-woven fabric or leather, and all the layers are joined in a non-slip arrangement and so as to be semi-permeable across their entire join surface, and the other layer of semi-permeable membrane has common join lines with at least one of the two other layers, which are welded or heat sealed, and preferably also stitched, making it impossible for the individual layers to come apart when the item of equipment is pulled off.

On one or both sides of the layer(s) made from a woven and/or non-woven fabric or leather with an anti-microbial effect and the other layer of semi-permeable membrane joined to one another so as to be semi-permeable, the internal lining may be provided with an additional layer made from a woven and/or non-woven fabric or leather and/or at least one other layer of semi-permeable membrane, which is joined so as a to be non-slip and semi-permeable to the semi-permeably joined layers of semi-permeable membrane and made from a woven and/or non-woven fabric or leather with an anti-microbial effect across the entire surface, in which case the join lines of the parts of the other semi-permeable membrane are welded, whereas the join lines of the two other layers made from a woven and/or non-woven fabric or leather are joined to one another separately from the first and/or the other membrane, preferably stitched, thereby avoiding perforating the membrane. If the membrane layer is joined on both sides to a layer made from woven and/or non-woven fabric or leather in the manner proposed by the invention, an item of equipment, in particular an item of clothing, incorporating this internal lining will be particularly comfortable to wear.

Furthermore, the layers both without and with an anti-microbial effect are made at least partially from woven and/or non-woven fabric or leather comprising natural or chemical fibres, offering a very versatile design and thus making the internal lining suitable for many applications. There is advantageously a large range of fibers with anti-microbial properties available, specifically aimed at end consumers, such as a range of sports socks, underwear and gloves, through to protective clothing designed for staff working in health care and the emergency services. The need for fibers with an anti-microbial effect is rising with the growing awareness of the special deodorizing or at least neutralizing properties of the products for which they are used.

It has proved to be of advantage to use natural fibers selected from a group comprising vegetable fibers, in particular plant fibers such as cotton for example, bast fibers such as flax, hemp, jute for example, hard fibers such as coconut, sisal for example, animal fibers, in particular wool and hair, such as sheepswool, llama, horsehair for example, silk, e.g. real silk, wild silk for example, mineral fibers and/or leather, thereby enabling good absorption capacity to be obtained. These materials have also proved to be practical due to their very good insulating properties, both as regards heat and cold.

In an alternative embodiment, chemical fibers from natural and/or synthetic polymers and/or organic raw materials are used, in which case the materials impart their intrinsic properties to the internal lining.

The natural polymers may be of vegetable and/or animal origin, such as cellulose fibers, alginate fibers, regenerated protein fibers and/or elasto-diene (rubber), in which case these materials will not cause any damage or at least unnatural damage to the environment during the manufacturing process.

In an alternative embodiment, the synthetic polymers are polymerisate fibers, such as polyacrylic, polychloride, polyethylene, polypropylene, elasto-diene, polycondensate fibers for example, such as polyamide, polyester, and/or polyaddition fibers, such as polyurethane, elastane for example, in which case these materials can also impart their intrinsic properties to the internal lining, such as a certain capacity to stretch, for example.

Organic raw materials may be used in the form of glass fibers, metal fibers and/or carbon fibers, in which case a certain degree of dimensional stability or stiffness can be imparted to the internal lining.

It has proved to be of advantage if the layers (3, 6) both without and with an anti-microbial effect are made at least partially from woven and/or non-woven fabric selected from a group comprising aramide and/or para-aramide fibers, such as Kevlar® (poly(p-phenylene terephthalamide), Nomex® (aramide comprising m-phenylene diamine and isophthalic acid), Twaron®, Technora, Teijinconex, phenol formaldehyde fibers, such as Kynol, polyamide/polyimide fibers such as Kermel, polybenzimidazole fibers or fiber mixtures thereof, thereby enabling flame-inhibiting and slash-proof properties to be achieved, for example.

Furthermore, several layers made from a woven and/or non-woven fabric or leather with an anti-microbial effect may be provided, and an anti-microbial property can be imparted to both the internal face of the internal lining, i.e. the side facing the wearer, which on the one hand reduces odor because bacterial growth is prevented, and on the other hand the anti-microbial layer can also be applied to the external face of the internal lining, in which case pathogenic substances which come into contact with the internal lining will not be able to unleash their effects at all.

In one embodiment, several layers made from a woven and/or non-woven fabric or leather are provided, thereby imparting higher resistance and hence a longer service life to the internal lining.

As regards a method whereby several layers, in particular at least one layer made from a woven and/or non-woven fabric or leather with an anti-microbial effect and another layer of semi-permeable membrane, are cut into individual pattern pieces corresponding to the desired internal lining and shaped, after which the at least two layers are placed at least partially congruently and joined to one another, possibly in a semi-permeable manner, it has proved to be of practical advantage that an internal lining can be assembled following standard procedures.

An additional layer made from a woven and/or non-woven fabric or leather is cut into individual pattern pieces corresponding to the desired internal lining and shaped, after which the layers are placed at least partially congruently and joined to one another, possibly by semi-permeable means, and the fact that several layers can be cut and joined to one another in the same way has proved to be of advantage because this enables the work process to be standardized. The respective joining method may be operated totally separately from the other layers and therefore totally adapted to the quality of the material of the respective layer.

An advantage found with an alternative embodiment is that the at least one layer made from a woven and/or non-woven fabric or leather with an anti-microbial effect and the at least one layer of semi-permeable membrane and optionally an additional layer made from a woven and/or non-woven fabric or leather are at least partially joined to one another prior to cutting, after which these layers are cut jointly and the pattern pieces joined so that they conform to the internal lining shape, as a result of which the pattern pieces incorporate the desired properties of the individual elements but in their entirety act as a single layer, optionally with different surfaces. For example, the layer with anti-microbial properties is disposed on one side of the layer of semi-permeable membrane and a woven fabric and/or knitted fabric or leather which might have heat-insulating properties in the form of a heat-insulating fiber pelt for example, is provided on the other side. If the internal lining comprising woven fabrics and/or knitted fabrics or leather and a semi-permeable membrane is joined to a layer completing the woven fabric or knitted fabric or leather on one or both sides in addition to the anti-microbial layer, it will be possible to produce internal linings which incorporate a combination of different types of properties depending on the woven fabrics used.

The layer made from a woven and/or non-woven fabric or leather with an anti-microbial effect is cut so that it complements the additional layer made from a woven and/or non-woven fabric or leather and/or so that it complements the layer of semi-permeable membrane, and in order to obtain an optimum join of the layer made from a woven and/or non-woven fabric or leather with an anti-microbial effect and the additional layer or the layer made from a woven and/or non-woven fabric or leather with an anti-microbial effect, the other layer of semi-permeable membrane and the additional layer, the seams lie on the side remote from the other layer and thus ensure a long service life of the item of equipment whilst maintaining full functionality.

It has proved to be of practical advantage to use the internal lining for sports, leisure and professional clothing because so many different properties, such as odour inhibiting, anti-microbial, temperature regulating, anti-static, water-repellent, air permeable properties, etc., can be combined in the internal lining proposed by the invention, thereby making it extremely versatile for different applications.

Also of advantage is the fact that the item of equipment can be used for clothing worn on the upper extremities, in particular gloves and mittens, on the lower extremities, e.g. for socks, shoes, boots, trousers, underwear, for the head, e.g. for hoods, caps, hats, masks, and for the torso, e.g. for jackets, coats, which again confirms the versatility of the internal lining.

The invention will be described in more detail below with reference to examples of embodiments illustrated in the appended drawings.

### BRIEF DESCRIPTION OF THE DRAWINGS

The invention will be described in more detail below with reference to examples of embodiments illustrated in the appended drawings.

FIG. 1 is a plan view of an item of equipment proposed by the invention;

FIG. 2 is a section through an internal lining comprising several layers;

FIG. 3 is a section through an internal lining proposed by the invention with join lines;

FIG. 4 is a section through an alternative embodiment of an internal lining proposed by the invention.

### DETAILED DESCRIPTION OF THE INVENTION

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

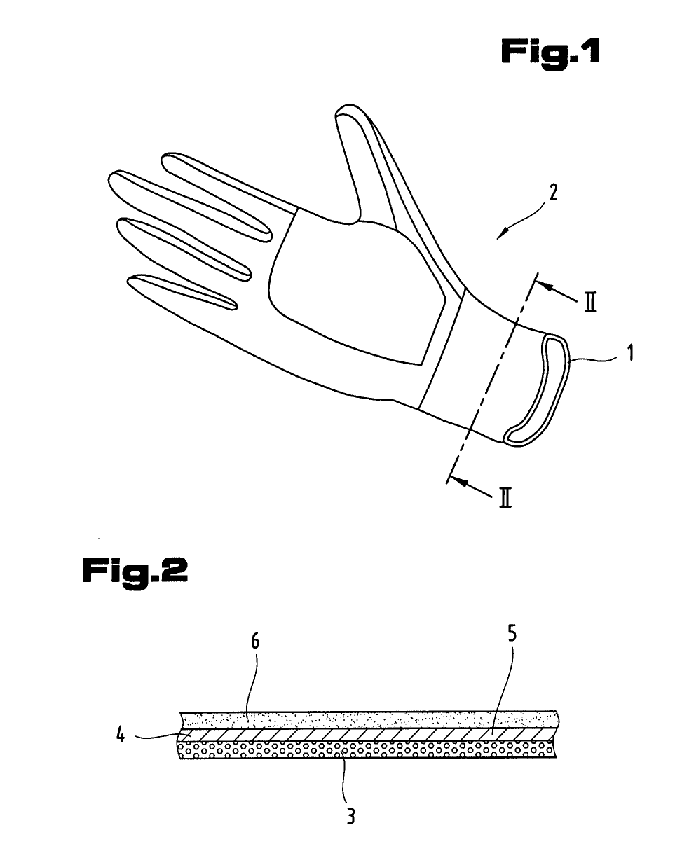

FIG. 1 shows a plan view of an item of equipment with the internal lining 1 disposed on the internal face, i.e. the side of the item of equipment 2 facing the hand.

At this stage, it should be pointed out that the internal lining 1 may constitute the outermost layer of an item of equipment 2. The internal face of a golf glove made from leather may have anti-microbial properties, but this is but one example. Alternatively, it would likewise be possible for a layer made from a woven fabric and/or knitted fabric to constitute the outermost layer of an item of equipment 2 for example and be of an anti-microbial design.

The internal lining 1 for an item of equipment 2 for at least temporarily covering parts of the body, in particular items of clothing, quilts, sleeping bags, comprises several layers.

FIG. 2 illustrates a section through an internal lining 1 proposed by the invention, comprising several layers. One layer 3 is made from a woven and/or non-woven fabric or leather with anti-bacterial properties, another layer 4 is made from a semi-permeable membrane 5, for example a laminate, preferably from polyvinyl chloride or polyurethane, and an additional layer 6 is made form a woven and/or non-woven fabric or leather. The semi-permeable membrane 5 may be made from polytetrafluoroethylene (PTFE), for example. The other layer 4 may be a laminate made from polyvinyl chloride, polyurethane, polyether amide, polyether ester amide, polyolefin components, polyester components or a mixture of these. This list of materials used for the internal lining 1 proposed by the invention, which should have both water-repellent properties but also be permeable to air, should not be construed as restricting the invention in any way.

Another layer 4 made from a semi-permeable membrane 5 is disposed adjacent to the layer 3 made from a woven and/or non-woven fabric or leather with an anti-microbial effect. In a preferred embodiment, the semi-permeable membrane 5 may also be disposed directly adjacent to the layer 3 made from a woven and/or non-woven fabric or leather with an anti-microbial effect.

Alternatively, the semi-permeable membrane 5 may also be disposed between the at least one layer 3 made from a woven and/or non-woven fabric or leather with an anti-microbial effect and an additional layer 6 made from a woven and/or non-woven fabric or leather.

Since the semi-permeable membrane 5 may cover the full surface of layers made from a woven and/or non-woven fabric on both sides and the join incorporating the individual layers must be non-slip, the layered material in its entirety acts as one layer with the properties of the membrane 5 lying in between. In alternative embodiments, the membrane or the laminate may be joined to the layers in a dotted or network pattern, which likewise products a slip-inhibiting effect.

The anti-microbial effect of the woven and/or non-woven fabric or leather is achieved by means of a metal. By using a metal, preferably silver, not only is an anti-microbial effect achieved, but also an anti-mycotic effect. Odor-forming bacteria are combated and killed and this prevents the formation of unpleasant odours. Using a metal is natural, non-toxic and there are no chemical products or pesticides, making this option environmentally friendly.

Metal has also been found to have a cooling effect in summer on the one hand and a warming effect in winter on the other hand. The reason for this is that metals have an extremely high and effective conductivity.

The metal used for the internal lining 1 is selected from a group comprising silver, gold, copper, platinum and/or a mixture of these. Silver is used in a preferred embodiment.

Silver has very good anti-static properties. Electric shocks which can be caused by static or friction are converted to zero by optimum distribution of the electrical energy.

Furthermore, pure silver is used, which occurs as a natural element. There are therefore no risks of poisoning for the user of the internal lining 1. Furthermore, the allergenic potential of pure silver is extremely low compared with “non-purified” metals.

In an alternative, preferred embodiment, gold is used, in which case the same properties as those of silver are obtained with an additional therapeutic effect, such as used for the treatment of patients with rheumatism, for example.

Using silver results in not only anti-microbial or anti-micro-biotic properties but also properties which prevent odours in the internal lining 1. Bacteria are just one of the reasons why the human body exudes odours. Ammonia and denatured proteins also make a significant contribution to the formation of odours in internal linings 1. Both ammonia and also denatured proteins bond readily with silver. Since the internal lining 1 contains silver on the internal face, this enables the ammonia and denatured proteins to form chemical bonds with silver rapidly, thereby initiating an immediate reduction of odours.

Using silver also keeps the amount of energy radiated by the human body low during cold seasons of the year. The most efficient method of using this energy is to direct it back to the source of emission or contain it. Silver also offers an ideal solution against the cold. In order to deal with cold, the problems of radiation, evaporation and convection must be solved. The reflection factor of the infrared rays of silver lies in excess of 95%. These values are much higher than all other elements and from a practical point of view, this means that 95% of the emitted energy which comes into contact with silver is reflected back to its source. Compared with other elements, silver has one of the lowest radiation rates. This equates to a very low irradiation rate of heat energy. Silver therefore remains warm for a very long time compared with other elements which can only hold heat for a very short time. Internal linings containing silver cause the heat which is not reflected onto the body to be absorbed by the internal lining 1 and stored, so that the internal lining 1 will keep the wearer warm for a longer period than is the case with conventional products produced using inactive fibres.

During warm seasons of the year, the most important mechanism of heat transmission is a conversion of energy which can lower the body temperature, the aim being to transmit heat to the surrounding environment. If it is not possible to give off sufficient heat by means of conduction or heat flow, the body uses evaporation. In this case, the result is sweat. In order to guarantee the wellbeing of the body, it is vital to remove moisture formed in this manner, which can be done using a semi-permeable membrane 5 in combination with the woven and/or non-woven fabric or leather with anti-microbial properties.

Heat transmission by convection can also be increased or reduced, depending on whether insulating or windproof materials are used, which can also be achieved by using the semi-permeable membrane 5. Using the semi-permeable membrane 5 also gives the internal lining 1 versatility for use in many applications. The semi-permeable membrane is able to protect the body of the wearer of the internal lining 1 from wetness and protects the wearer against wind and poor weather conditions.

By combining the properties of the semi-permeable membrane 5 and the silver, the internal lining 1 is able to keep the wearer dry and regulate temperature. The wearer does not sweat and therefore does not smell.

If silver with other water-repellent materials is placed in a moist environment, the conduction properties increase the rate of evaporation of the moisture. As this moisture is being transformed by evaporation, an even bigger quantity of moisture can be brought into contact with the water-repellent semi-permeable membrane 5 and thus evaporated. As a result, internal linings 1 containing silver reduce body moisture and hence induce a more comfortable environment faster and also reduce loss through convection.

As the temperature increases, irradiation decreases. One of the main reasons for this is heat transmission. It is absorbed by silver due to heat conduction and evaporation. Compared with all the other elements, silver has the highest heat conducting capacity. In other words, internal linings 1 containing silver actively work to distribute the heat rapidly and uniformly throughout the entire internal lining 1. During hot seasons when heat transmission is the main means of converting heat, an internal lining 1 containing silver promotes the natural body function by increasing the heat transmitted from the skin. By contrast with this, a conventional material merely stands in the way of heat transmission and acts as a barrier. Silver conducts the heat from the skin into the surrounding environment and thus promotes cooling of the body. Due to the transmission of moisture by silver, moisture on the skin is also reduced to a minimum, thereby increasing the body's wellbeing.

An internal lining 1 containing silver can also fulfil an anti-static function and offers major advantages both in industry and in applications for consumer goods. Most people find an electric shock caused by static or friction of the material on the skin unpleasant. In certain industrial applications, this phenomenon also poses a major risk.

Static electricity is caused by static charges or by friction energy. A very high charge can be generated by internal linings 1 made from synthetic materials. The only way of reducing or eliminating these unpleasant effects is to distribute the electric charge by means of conductive materials. Compared with all other elements, silver has the highest conductivity. Even very small quantities of silver in the internal lining 1 enable electric charges caused by friction to be distributed and reduce the unpleasant electric charges caused as a result.

Silver, gold, platinum, copper, etc. in internal linings 1 also exhibit therapeutic properties. This is primarily due to the use of the electric and thermal conductivity of silver. The human body has thousands of nerve strands, which terminate at the surface of the skin. The body uses these nerves as a means of triggering different electric signals, e.g. for the perception of pain and discomfort. Since silver is the material with the highest conductivity, internal linings 1 containing silver collect these electric charges located on the skin and distribute them, thereby reducing the feeling of discomfort.

The electric flows which exist in the human body and which are distributed by an internal lining 1 containing silver form a magnetic field around the body, and whenever electricity passes through the body, a magnetic field is created. In addition to widespread convictions that magnetic therapy should be recommended for healthy wellbeing, published research findings by reputable health institutions agree with the view that products with magnetic properties have the capacity to drive the blood circulation and reduce swellings, for example. The internal lining 1 proposed by the invention therefore has a medical perceptibly positive effect on the wearer.

The metal, in particular silver, accounts for a proportion by percentage with an upper threshold of 80%, preferably 35%, in particular 20% and a lower threshold of 0.5%, preferably 1%, in particular 5%, in the layer (3) made from woven and/or non-woven fabric or leather of the internal lining 1. In a preferred embodiment, 6 to 20% silver is used in the layer 3. In spite of using silver for the internal lining 1, wearing comfort and the original textile properties and suppleness are still preserved.

Pure metals are used, which thus makes outbreaks of allergies highly unlikely.

The metal is incorporated in the internal lining 1 in a filament, in a fibre, a spunbonded yarn or fibre. Filaments, fibres, spunbonded yarns or spunbonded fibers incorporating metal which are used to produce the woven and/or non-woven fabric are incorporated in any form in the woven fabric containing the silver, which is disposed on the internal surface or the contact surface of the internal lining 1 which comes into contact with the wearer's skin so that the properties of the silver can be put to the best possible use. The joining of the silver to the filament, fibre and/or spunbonded fiber or spunbonded yarn is permanent and irreversible. |It does not wash out and it does not become detached.

In an alternative embodiment, the metal may be applied to the at least one layer (3) made from a woven and/or non-woven fabric or leather and/or other layer (4), preferably of semi-permeable membrane (5) in the form of a powder. If the metal is applied in particulate form, the particle size may be selected from a range with a lower threshold of 0.2 μm, preferably 5 μm, in particular 20 μm, and an upper range of 500 μm, preferably 250 μm, in particular 200 μm. In alternative embodiments, however, it would be conceivable for the metal to be flocculated, adhered, coated, vapour deposited, sprayed, dipped and or impregnated.

In one embodiment of the internal lining, the at least one layer 3 made from a woven and/or non-woven fabric or leather with an anti-microbial effect is applied to the at least one other layer 4 of semi-permeable membrane 5 by the full surface or only partially, in particular in a dotted or network pattern, for example is flocculated, adhered, laminated, coated, vapour deposited, sprayed, dipped or impregnated. The other layer 3 therefore need not necessarily have a solid surface but may also have a pattern or more or less regular structures. As mentioned above, the layer 3 may also be flocculated onto the other layer 4 for example, and may already be integrated during the production process so that the anti-microbial and semi-permeable properties are combined with one another in one layer.

For internal linings used in items of clothing, such as gloves for example, whereby a plurality of pattern pieces have to be joined to one another, the pattern pieces of the other layer 4 of semi-permeable membrane 5 can be joined to one another in a known manner by welding, for example, whereas the pattern pieces of the layers 3, 6 made from a woven and/or non-woven fabric or leather with or without an anti-microbial effect can be stitched to one another in a standard, working-saving manner. These layers 3, 4, 6, which are joined to one another so as to be semi-permeable across their entire common surface, adhere to one another in a non-slip arrangement and the internal lining as a whole therefore has the desired properties of the membrane layer 5 as well as the layer 3 with an anti-microbial effect itself.

Alternatively—although involving more work—the membrane and other layers made from woven and/or non-woven fabric or leather may firstly be joined by their entire surface so that they are non-slip and semi-permeable, after which they are cut into the requisite parts and joined in the desired shape, for example stitched, and these join lines are then subsequently welded or sealed to seal off any perforations in the membrane. Another layer comprising joined, preferably stitched, complementary pattern pieces made from woven and/or non-woven fabric or leather is then joined to the other membrane side, again by the entire common surface, in a non-slip and semi-permeable arrangement. This approach, although slightly more complex, can be of advantage for certain items of clothing which require particularly strong seams. It is also possible to use a prefabricated material comprising a layer 4 of semi-permeable membrane 5 and at least one layer 3, 6 made from a woven and/or non-woven fabric with or without anti-microbial effect, joined to it on one side.

The one layer 3 made from a woven and/or non-woven fabric or leather with an anti-microbial effect and the other layer 4 of semi-permeable membrane 5 are joined to one another by their full surface. In a preferred embodiment, these two layers 3, 4 are joined directly to one another by their surface, in which case the join need not necessarily be a full surface join but may be only a partial or dotted or lattice type join. As a result, the two layers 3, 4 are joined to one another in a non-slip arrangement across a part of the surface.

The one layer 3 made from a woven and/or non-woven fabric or leather with an anti-microbial effect and at least the other layer 4 of semi-permeable membrane and the additional layer 6 made from a woven and/or non-woven fabric or leather may be directly joined to one another by their surface. In a preferred embodiment, these layers 3, 4, 6 may also be joined to one another in a non-slip arrangement across only a part of the surface.

The individual layers 3, 4, 6 may also be joined to one another with their surfaces congruent and in a non-slip arrangement whereby the individual layers 3, 4, 6 in their entirety act in the manner of a woven and/or non-woven fabric based on the properties of the materials made from the woven and/or non-woven fabric.

The at least one layer 3 made from a woven and/or non-woven fabric or leather with an anti-microbial effect is at least partially joined to the other layer 4 of semi-permeable membrane, in particular at their contact surface, in the form of a plurality of dots, optionally by means of an activatable adhesive layer. In an alternative embodiment, the additional layer 6 made from a woven and/or non-woven fabric or leather is also joined to the layer 3 made from a woven and/or non-woven fabric or leather with an anti-microbial effect and the other layer 4 of semi-permeable membrane 5 at least partially or at their contact surface in the form of a plurality of dots. This join may also be made by means of an activatable adhesive layer.

The present invention also describes the way in which the layer 3 made from a woven and/or non-woven fabric or leather with an anti-microbial effect is joined to the other layer 4 of semi-permeable membrane 5. The joining method corresponds to that disclosed in patent specification EP 0 646 061 B1.

In order to join the individual layers 3, 4, 6, the adhesive agent to be intermittently applied is applied to the individual layers before they are processed. To this end, it has proved to be of practical advantage to use an activatable adhesive agent. In other words layers comprising cut and joined pattern pieces layers may be placed with their surfaces congruent and oriented. Only then is the adhesive agent activated, for example by heat or pressure, and the individual layers are joined to one another in the desired manner, irrespective of whether they have been processed or not. Alternatively, when the adhesive agent is activated, particulate metals incorporating a resin can be applied to the woven and/or non-woven fabric or leather simultaneously with the activatable adhesive layer by applying heat or pressure, thereby imparting the anti-microbial properties to the internal lining 1.

However, the adhesive agent, which may be activatable or a contact adhesive, could also be applied after processing and joining the pattern pieces, for example sprayed on.

The adhesive layer may be applied either to the layer 3 made from a woven and/or non-woven fabric with an anti-microbial effect or to the other layer 4 of semi-permeable membrane 5 but it is preferable to apply it to the layer 3 because this can be done in the same work operation as that when the joining means are applied. The joining means and the adhesive layer can therefore be applied in the same way, in strips or in a lattice pattern or in the form of a plurality of dots.

The joining means may be an applied coating compound or an adhesive layer. If it is applied to the full surface, it is vital that it is permeable in the same way as the semi-permeable membrane 5 itself. As mentioned above, the join may be only a partial join by means of fibres, of the type obtained by flame coating for example.

The individual layers 3, 4, 6 may also be joined by bonding, welding, hotsealing, lamination stitching, etc., along the join lines.

If the layer 4 of semi-permeable membrane 5 is faced with a layer 3, 6 made from a woven and/or non-woven fabric with or without anti-microbial effect on both its surfaces, the internal lining 1 as a whole will incorporate the desired properties of the semi-permeable membrane 5 but will act as it if it were a single layer 3, 6 made from a woven and/or non-woven fabric or leather, optionally with different surfaces. For example, a non-woven material may be applied to one side of the layer 4 but a heat-insulating fibre pelt may be applied to the other side.

If the internal lining 1 comprises a layer 3 made from a woven and/or non-woven fabric or leather with an anti-microbial effect and a layer 4 of semi-permeable membrane 5 is joined at one or both of its sides to an other layer 6 made from a woven and/or non-woven fabric or leather or also to another layer 4 of semi-permeable membrane 5, and it would therefore be conceivably be possible to produce internal linings 1 combining different properties imparted by different layers 3, 6 made from a woven and/or non-woven fabric or leather, and by the different membranes, in which case each of these layers, whether they are layers 3, 6 made from a woven and/or non-woven fabric or leather or layers 4 of semi-permeable membrane 5 will comprise pattern pieces joined to one another. The joining method in each case can therefore be adapted separately from one layer to another and totally depending on the quality of the respective material.

In the case of a layered material processed in webs, such as for sleeping bag internal linings 1 for example, the adhesive layer may be a contact adhesive so that when facing two layers 3, 6 made from a woven and/or non-woven fabric in the same work operation, the semi-permeable membrane 5 can be joined in the same work operation. If, however, there are more pattern pieces to be joined and the processing steps are more complex, as is the case with glove-internal linings 1 for example, it is preferable to use an adhesive layer which has to be activated first.

The layer 3 made from a woven and/or non-woven fabric or leather with an anti-microbial effect and the additional layer 6 made from a woven and/or non-woven fabric or leather may be at least partially made from natural and/or chemical fibres. The natural fibers may be selected from a group comprising vegetable fibres, in particular plant fibers, such as cotton for example, bast fibres such as flax, hemp, jute for example, hard fibers such as coconut, sisal for example, animal fibres, in particular wool and hair, such as sheepswool, llama, horse hair for example, silk such as real silk, wild silk for example, mineral fibers and/or leather.

The chemical fibres may be natural and/or synthetic polymers and/or organic raw materials, and the natural polymers may be of vegetable or animal origin, such as cellulose, alginate, regenerated protein fibers and/or elasto-diene (rubber) for example.

The synthetic polymers may be polymerisate fibers, such as polyacrylic, polychloride, polyethylene, polypropylene fibers, elasto-diene for example, polycondensate fibres such as polyamide, polyester for example, and/or polyaddition fibres such as polyurethane, elastane for example.

The organic raw materials used to make the layer 3 made from a woven and/or non-woven fabric and for the additional layer 6 made from a woven and/or non-woven fabric may be glass fibres, metal fibers and/or carbon fibers.

To enable flame retarding and slash-proof properties to be imparted to the internal lining 1, the layers (3, 6) both without and with an anti-microbial effect, may be at least partially made from woven and/or non-woven fabric selected from a group comprising aramide and/or para-aramide fiber such as Kevlar® (poly(p-phenylene-terephthalamide), Nomex® (aramide comprising m-phenylene diamine and isophthalic acid), Twaron®, Technora, Teijinconex, phenol-formaldehyde fibres such as Kynol, polyamide/polyimide fibres such as Kermel, polybenzimidazole fiber or fiber mixtures of these.

In alternative embodiments, it would naturally also be conceivable to provide several layers of one type, i.e. both several layers 3 made from a woven and/or non-woven fabric or leather with an anti-microbial effect. Alternatively, it would also be possible for several layers of the additional layer 6 made from a woven fabric and/or knitted fabric or leather to be used.

If joining several layers, however, care must be taken to ensure that the properties of the semi-permeable membrane 5 and the property of the layer 3 of the woven and/or non-woven fabric or leather with anti-microbial properties are not detrimentally affected by the type of facing method used. This being the case, care must be taken to ensure that the joining means, e.g. the adhesive agent, is uniformly distributed between the membrane and woven and/or non-woven fabric or leather layer but only partially, or so that it is itself semi-permeable if applied to the respective layer. The adhesive agent, which may be of the activatable type or contact adhesive, can also be applied, for example sprayed on, after processing and joining the pattern pieces.

If designed to withstand higher stress due to wind and weather, it would be conceivable to provide several layers 4 of semi-permeable membrane 5.

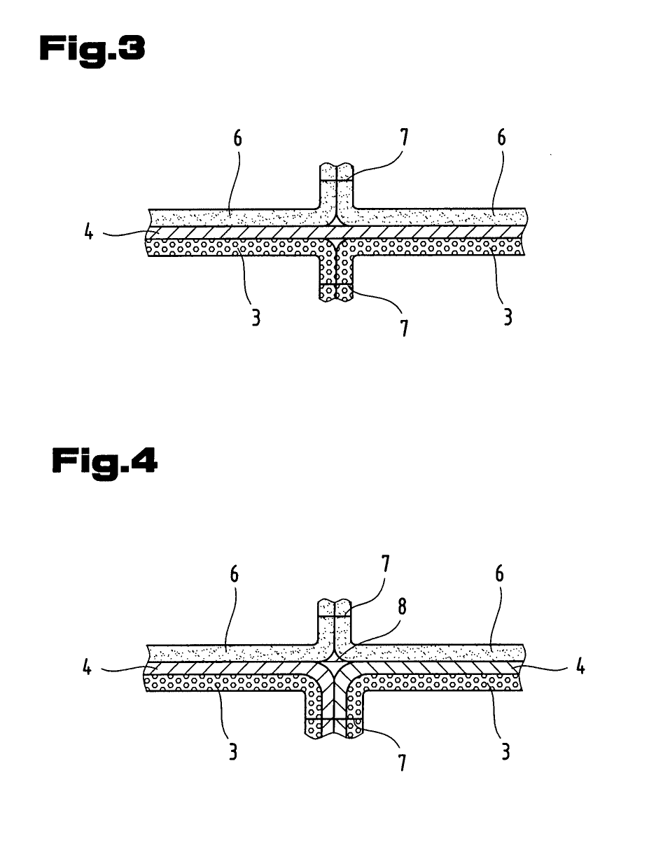

FIG. 3 illustrates a section through an internal lining 1 proposed by the invention. To achieve this, the other layer 4 of semi-permeable membrane 5 and the layers 3, 6 made from woven and/or non-woven fabric or leather are cut to the requisite pattern pieces. The pattern pieces are then joined to one another in a known manner, for example by a welded join. Accordingly, the semi-permeable membrane 5 remains intact because it is not pierced by stitching and the internal lining 1 as a whole is therefore perfectly semi-permeable. The layers 3, 6 made from woven and/or non-woven fabric or leather are stitched to one another in the standard manner at the join line 7 and thus form layers of the internal lining 1. The resultant individual layers 3, 4, 6 are then placed one on top of the other with their surfaces at least partially congruent and oriented, and in the case of producing a glove preferably placed over a hand model, and heated either from outside and/or—by means of a heatable hand model—from inside, so that the adhesive layers between the layer 4 of semi-permeable membrane 5 and the layers 3, 6 made from a woven and/or non-woven fabric or leather with or without anti-microbial effect are activated. All three layers 3, 4, 6 now form a single internal lining 1 with a semi-permeable property of textile quality.

Since the join lines 7 on the layers 3, 6 of the internal lining 1 should lie remote from the membrane 5 in the manner illustrated in FIG. 3 in order to guarantee the best possible bonded join to the layer 4 of semi-permeable membrane 5 precisely at the adjoining faces of the layers 3, 6, care must be taken when cutting the respective corresponding parts of the lining to ensure that they complement one another.

FIG. 4 illustrates an alternative to this internal lining 1 and in this case—unlike the situation illustrated in FIG. 3—the layer 4 of semi-permeable membrane 5 and the layers made from woven and/or non-woven fabric or leather with or without anti-microbial effect are cut into the requisite pattern pieces separately from one another. This process starts with a layered material corresponding to that illustrated in FIG. 1, whereby the semi-permeable membrane 5 and at least one layer 3, 6 made from a woven and/or non-woven fabric or leather are joined to one another across their entire surface in the manner described above so that they are semi-permeable. This layered material is then cut into the requisite pattern pieces which are then joined, preferably stitched for example, on a join line 7. Since perforations can occur in the semi-permeable membrane 5, thereby reducing its semi-permeability, these join lines 7 must additionally be welded or sealed by means of a seal 8. The layer 3 made from a woven and/or non-woven fabric or leather with an anti-microbial effect, however, is cut into pattern pieces separately optionally together with an additional layer 6 made from a woven and/or non-woven fabric or leather, which maybe lined, which are joined to one another at the join line 7, for example stitched. This being the case, the join line 7 advantageously points outwards away from the semi-permeable membrane 5 so that when the two internal lining layers 3, 6 are being joined by means of the adhesive substance, perfect adhesion is also obtained precisely at all the layers of the pattern parts on the common join line 7 whilst simultaneously preserving the semi-permeability of the internal lining as a whole. The finished internal lining 1 is then fitted, for example in the glove.

Whilst in the case of the internal linings 1 illustrated in FIGS. 3 and 4 the layers 3, 6 made from a woven and/or non-woven fabric or leather come into contact with the internal face of the glove, which makes it much more difficult to pull out the internal lining 1 simultaneously when pulling off the glove, this is made impossible due to an additional adhesive layer applied on the layer 3, 6 made from a woven and/or non-woven fabric or leather in the described manner, which is firmly joined to the outer glove and the internal lining 1 once activated.

A broad range is available for selecting and joining the individual layers of the internal lining 1, which may also be combined with one another, as described above.

Another conceivable option is an internal lining 1 of this type comprising several layers and the combination of different membranes with different properties.

The invention also relates to a method of producing an internal lining, whereby several layers, in particular at least one layer 3 made from a woven and/or non-woven fabric or leather with an anti-microbial effect and another layer 4 of semi-permeable membrane 5 are cut into desired pattern pieces corresponding to the desired internal lining 1 and shaped, in particular each layer 3, 4 being processed separately, after which the at least two layers 3, 4 can be at least partially joined to one another.

In one embodiment of the method, the layers 3 and 4 and the additional layer 6 made from a woven and/or non-woven fabric or leather can be cut into individual pattern pieces corresponding to the desired internal lining 1 and shaped, after which the at least three layers 3, 4, 6 are at least partially congruently joined to one another.

In alternative embodiments of the invention, it would also be possible for several of said three layers 3, 4, 6 to be cut into individual pattern pieces corresponding to the internal lining 1 and these layers are then joined to one another at least partially congruently.

In another alternative, the at least one layer 3 made from a woven fabric and/or knitted fabric or leather with an anti-microbial effect and the other layer 4 of semi-permeable membrane 5 are at least partially joined to one another prior to cutting, after which these layers 3, 4 are cut jointly and the pattern pieces joined to produce the internal lining shape.

As mentioned above, an additional layer 6 made from a woven and/or non-woven fabric or leather can also be at least partially joined to the two layers 3 and 4 prior to cutting, after which these three layers 3, 4, 6 are cut jointly and the pattern pieces are joined to produce the requisite internal lining shape.

The internal lining 1 maybe used for producing gloves or mittens in which the first finger and fingers 2 to 5 are disposed in one respective unit or finger 1, finger 2, and fingers 3, 4, and 5 respectively form a unit or finger 1, fingers 2 and 3, and fingers 4 and 5 respectively form a unit, as well as hats, hoods, caps, socks, shoes, boots, jackets, trousers, coats, masks, underwear, etc.

Generally speaking, the internal lining 1 may be used to manufacture sports, leisure and/or professional clothing.

This internal lining 1 may be used to manufacture items of equipment 2 comprising a layer 3 made from a woven and/or non-woven fabric or leather with an anti-microbial effect and another layer 4 of a semi-permeable membrane 5. The items of equipment 2 may also incorporate an additional layer 6 made from a woven and/or non-woven fabric or leather, which is added to the layer 3 and other layer 4.

The item of equipment 2 may also incorporate yet other layers which impart certain other properties to the item of equipment 2, for example, such as the use of flame-retardant materials to impart a certain resistance to heat or by using slash-proof materials to impart a certain resistance to sharp objects such as knives and similar. These properties can be enhanced or complemented by using special materials of types known from the prior art.

The item of equipment 2 proposed by the invention is used to manufacture clothing for the upper extremities, in particular gloves, mittens, and for the lower extremities, such as socks, shoes, boots, trousers, underwear for example, for the head, such as hoods, caps, hats, masks for example and for the torso such as jackets and coats, etc.

In a preferred embodiment, the internal lining 1 proposed by the invention is used for lining a glove, in particular a work glove or sports glove, because in this application odour-inhibiting, anti-microbial, temperature regulating, anti-static, water-repellent properties but also air permeability are the most urgently needed properties. A glove or mitten with the internal lining 1 proposed by the invention may generally be used in professional clothing for the military, police force, civilian officers, public services, fire services, etc.

The embodiments illustrated as examples represent possible design variants of the internal lining 1 and item of equipment 2 and it should be pointed out at this stage that the invention is not specifically limited to the design variants specifically illustrated, and instead the individual design variants may be used in different combinations with one another and these possible variations lie within the reach of the person skilled in this technical field given the disclosed technical teaching. Accordingly, all conceivable design variants which can be obtained by combining individual details of the design variants described and illustrated are possible and fall within the scope of the invention.

Above all, the individual embodiments of the subject matter illustrated in FIGS. 2; 3, and 4 constitute independent solutions proposed by the invention in their own right. The objectives and associated solutions proposed by the invention may be found in the detailed descriptions of these drawings.

The tasks underlying the independent inventive solutions can be found in the description.

For the sake of good order, it should finally be pointed out that in order to provide a clearer understanding of the structure of the internal lining, it and its constituent parts have been illustrated out of scale to a certain extent and/or on an enlarged and/or reduced scale.

### LIST OF REFERENCE NUMBERS

1 Internal lining
2 Item of equipment
3 Layer
4 Other layer
5 Semi-permeable membrane
6 Additional layer
7 Join line
8 Seal

What is claimed is:

1. An internal lining of several layers for an item of equipment for at least temporarily covering body parts, comprising at least one layer made from a woven fabric and/or knitted and/or non-woven fabric with an anti-microbial effect wherein the fabric contains a metal, which metal is integrated in a filament, a fiber and/or a spunbonded fiber or spunbonded yarn; and at least one other layer of a semi-permeable membrane made from polytetrafluoroethylene (PTFE), and/or a polymeric laminate.

2. The internal lining as claimed in claim 1 wherein said item of equipment comprises items of clothing, quilts, or sleeping bags.

3. The internal lining as claimed in claim 1 wherein said laminate comprises polyvinyl chloride, polyurethane, polyether amide, polyether ester amide, polyolefin components, polyester components, or a mixture of thereof.

4. The internal lining as claimed in claim 1 wherein said item of equipment comprises items of clothing, quilts, or sleeping bags.

5. The internal lining as claimed in claim 1 wherein said laminate comprises polyvinyl chloride, polyurethane, polyether amide, polyether ester amide, polyolefin components, polyester components, or a mixture of thereof.

6. The internal lining as claimed in claim 21, wherein the said metal is selected from a group comprising silver, gold, copper, platinum, or a mixture of thereof.

7. The internal lining as claimed in claim 1, wherein said metal represents a proportion by percentage with an upper threshold of 35%, and a lower threshold of 1%, of the layer made from a woven and/or non-woven fabric or leather with an anti-microbial effect.

8. The internal lining as claimed in claim 1, wherein said metal represents a proportion by percentage with an upper threshold of 20%, and a lower threshold of 5%, of the layer made from a woven and/or non-woven fabric or leather with an anti-microbial effect.

9. The internal lining as claimed in claim 1, wherein said metal comprises silver.

10. The internal lining as claimed in claim 1, wherein said metal is applied to the at least one layer made from a woven fabric and/or knitted and/or non-woven fabric and/or other layer of semi-permeable membrane in the form of a coating or a powder.

11. The internal lining as claimed in claim 10, wherein said metal in a particulate form comprises a particle size in a range from a lower threshold of 0.2 μm to an upper threshold of 500 μm.

12. The internal lining as claimed in claim 10, wherein said metal in a particulate form comprises a particle size in a range from a lower threshold of 5 μm to an upper threshold of 250 μm.

13. The internal lining as claimed in claim 10, wherein said metal in a particulate form comprises a particle size in a range from a lower threshold of 20 μm to an upper threshold of 200 μm.

14. The internal lining as claimed in claim 10, wherein said metal is flocculated, adhered, laminated, coated, vapour deposited, sprayed, dipped and/or impregnated.

15. The internal lining as claimed in claim 1, wherein said at least one other layer of semi-permeable membrane is disposed adjacent, or optionally directly adjacent, to said at least one layer made from a woven fabric and/or knitted fabric with an anti-microbial effect.

16. The internal lining as claimed in claim 1, wherein said at least one layer made from a woven fabric and/or knitted and/or non-woven fabric with an anti-microbial effect is applied to said at least one other layer of semi-permeable membrane by its full surface or partially in a dotted or network pattern.

17. The internal lining as claimed in claim 1, wherein said pattern is flocculated, adhered, laminated, coated, vapor deposited, coated, sprayed, dipped and/or impregnated.

18. The internal lining as claimed in claim 1, wherein said other layer of semi-permeable membrane is disposed between said at least one layer made from a woven fabric and/or knitted and/or non-woven fabric with an anti-microbial effect and an additional layer made from a woven fabric and/or knitted and/or non-woven fabric.

19. The internal lining as claimed in claim 1, wherein said at least one other layer of semi-permeable membrane, said at least one layer made from a woven fabric and/or knitted and/or non-woven fabric with an anti-microbial effect, and, optionally, said additional layer made from a woven fabric and/or knitted and/or non-woven fabric are joined to one another by their surface.

20. The internal lining as claimed in claim 1, wherein said at least one other layer of semi-permeable membrane, said at least one layer made from a woven fabric and/or knitted and/or non-woven fabric with an anti-microbial effect, and, optionally, said additional layer made from a woven fabric and/or knitted and/or non-woven fabric are joined to one another across a part of the surface in a non-slip arrangement.

21. The internal lining as claimed in claim 1, wherein said at least one layer made from a woven fabric and/or knitted and/or non-woven fabric with an anti-microbial effect, and said at least one other layer of semi-permeable membrane, and, optionally, said additional layer made from a woven fabric and/or knitted and/or non-woven fabric are joined to one another at least partially, in particular at their contact surfaces, in the form of a plurality of dots or a network pattern, optionally by an activatable adhesive layer.

22. The internal lining as claimed in claim 1, wherein said layers can be joined to one another by bonding, welding, hot sealing, lamination and/or stitching along join lines.

23. The internal lining as claimed in claim 1, comprising at least one layer of pattern pieces of said at least a woven fabric and/or knitted and/or non-woven fabric with an anti-microbial effect on the one hand and said at least one other layer of semi-permeable membrane on the other hand joined to one another along join lines, wherein said layers are joined to one another so as to be non-slip and semi-permeable across their entire joint surface, said join lines of the other layer of semi-permeable membrane being welded, and said join lines of the parts of the layer made from a woven fabric and/or knitted and/or non-woven fabric with an anti-microbial effect being joined to one another separately from the other layer of semi-permeable membrane.

24. The internal lining as claimed in claim 22, wherein said join lines of the parts of the layer made from a woven fabric and/or knitted and/or non-woven fabric with an anti-microbial effect being stitched to one another.

25. The internal lining as claimed in claim 1, wherein said other layer of a semi-permeable membrane is disposed between said at least one first layer made from a woven fabric and/or knitted and/or non-woven fabric with an anti-microbial effect and said additional second layer made from a woven fabric and/or knitted and/or non-woven fabric, said layers being joined to one another across their entire common surface, wherein said other layer of semi-permeable membrane has common join lines with said at least one first layer or said additional second layer.

26. The internal lining as claimed in claim 1, wherein said join lines are welded or heat sealed, and preferably also stitched.

27. The internal lining as claimed in claim 23, wherein said joined semi-permeable layer(s) of said at least one layer a woven fabric and/or knitted and/or non-woven fabric with an anti-microbial effect and said other layer of semi-permeable membrane is provided on one or both sides with at least one additional layer made from a woven fabric and/or knitted and/or non-woven fabric and/or at least one additional other layer of semi-permeable membrane, which additional layer(s) is/are joined to said joined semi-permeable layers essentially across the entire surface so as to be non-slip and semi-permeable, the join lines of the parts of the other semi-permeable membrane being welded, whilst said join lines of said layers of a woven fabric and/or knitted and/or non-woven fabric are stitched to one another separately from said additional layer(s) of semi-permeable membrane.

28. The internal lining as claimed in claim 23, wherein said layers without or with an anti-microbial effect made from woven fabric and/or knitted and/or non-woven fabric are at least partially made from natural and/or chemical fibers.

29. The internal lining as claimed in claim 27, wherein the natural fibers comprise plant fibers, or animal fibers.

30. The internal lining as claimed in claim 27, wherein said plant fibers comprise fruit such as cotton; bast fibers such as flax, hemp, or jute; hard fibers such as coconut, sisal; or wherein animal fibers comprise wool and hair such as sheepswool, llama, horse hair, silk, such as real silk, or wild silk.

31. The internal lining as claimed in claim 27, wherein the chemical fibers are natural and/or synthetic polymers and/or organic raw materials.

32. The internal lining as claimed in claim 30, wherein the natural polymers are of vegetable and/or animal origin, such as cellulose fibers, alginate fibers, regenerated protein fibers and/or elasto-diene (rubber).

33. The internal lining as claimed in claim 30, wherein the synthetic polymers are
(i) polymerizate fibers comprising polyacrylic, polychloride, polyethylene, polypropylene fibers, elasto-diene,
(ii) polycondensate fibres comprising polyamide, polyester, and/or
(iii) polyaddition fibres comprising polyurethane, elastane.

34. The internal lining as claimed in claim 30, wherein the organic raw materials comprise glass fibers, metal fibers and/or carbon fibers.

35. The internal lining as claimed in claim 1, wherein said layers without and with an anti-microbial effect are at least partially made from woven fabric and/or knitted and/or non-woven fabric comprising aramide and/or para-aramide fibers such as Kevlar® (poly(p-phenylene terephthalamide), Nomex® (aramide comprising m-phenylene diamine and isophthalic acid), Twaron®, Technora, Teijinconex, phenol formaldehyde fibers such as Kynol, polyamide/polyimide fibers such as Kermel, polybenzimidazole fibers or fiber mixtures thereof.

36. The internal lining as claimed in claim 1, wherein several layers made from a woven fabric and/or knitted and/or non-woven fabric with an anti-microbial effect are provided.

37. The internal lining as claimed in claim 1, wherein several layers made from a woven fabric and/or knitted and/or non-woven fabric or leather are provided.

38. A method of producing an internal lining of several layers comprising:
(i) cutting and shaping at least one metal containing layer made from a woven fabric and/or knitted and/or non-woven fabric with an anti-microbial effect, which metal is integrated in a filament, a fiber and/or a spunbonded fiber or spunbonded yarn, and another layer of semi-permeable membrane into individual pattern pieces corresponding to the desired internal lining, and
(ii) joining at least two of said layers to one another at least partially congruently and optionally so as to be semi-permeable.

39. The method of producing an internal lining as claimed in claim 37, wherein the several layers, including an additional layer made from a woven fabric and/or knitted and/or non-woven fabric, are cut into individual pattern pieces corresponding to the desired internal lining and shaped, after which the layers are joined to one another at least partially congruently and optionally so as to be semi-permeable.

40. The method of producing an internal lining as claimed in claim 37, wherein the at least one layer made from a woven fabric and/or knitted and/or non-woven fabric with an anti-microbial effect containing a metal, and the at least one layer of semi-permeable membrane are cut at least partially joined to one another prior to cutting, after which these layers are cut jointly and the pattern pieces are joined to assume the desired internal lining shape.

41. The method of producing an internal lining as claimed in claim 37, wherein at least one additional layer made from a woven fabric and/or knitted and/or non-woven fabric or from leather, the at least one layer made from a woven fabric and/or knitted and/or non-woven fabric with an anti-microbial effect and the layer of semi-permeable membrane are at least partially joined to one another prior to cutting, after which these layers are cut jointly, and the pattern pieces are joined to assume the internal lining shape.

42. The method of producing an internal lining as claimed in claim 37, wherein the layer made from a woven fabric and/or knitted and/or non-woven fabric with an anti-microbial effect is cut so that it complements the layer made from a woven fabric and/or knitted and/or non-woven fabric or leather.

43. The method of producing an internal lining as claimed in claim 37, wherein the layer made from a woven fabric and/or knitted and/or non-woven fabric with an anti-microbial effect is cut so that it complements the layer of semi-permeable membrane and the additional layer made from a woven fabric and/or knitted and/or non-woven fabric or leather.

44. The internal lining as claimed in claim 1 wherein the item of equipment comprises gloves, mittens, hats, hoods, caps, socks, shoes, boots, jackets, coats, masks, or underwear.

45. The internal lining as claimed in claim 1 wherein the item of equipment is found in sports, leisure and/or professional clothing.

46. An item of equipment with an internal lining as claimed in claim 1, wherein the internal lining comprises a layer of semi-permeable membrane and a layer made from woven fabric and/or knitted and/or non-woven fabric with anti-microbial properties and optionally an additional layer made from a woven fabric and/or knitted and/or non-woven fabric or leather.

47. The item of equipment as claimed in claim 45, wherein an item of clothing for the upper extremities, in particular gloves, for the lower extremities, such as for socks, shoes, boots, trousers, underwear for example, for the head, such as hoods, caps, hats, masks for example, and for the torso such as jackets, or coats.
